(19) United States
(12) Patent Application Publication
(10) Pub. No.: US 2006/0136276 A1
(43) Pub. Date: Jun. 22, 2006

(54) System and method for linking quality function deployment to system engineering

(75) Inventor: Thierry Schmitt, Antony (FR)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 11/293,995

(22) Filed: Dec. 5, 2005

(30) Foreign Application Priority Data
Dec. 20, 2004 (FR) 04300922.4

(51) Int. Cl. G06F 9/44

(52) U.S. Cl. 705/7

(57) ABSTRACT

The present invention is directed to a method, system, and computer program managing a product lifecycle. In a preferred embodiment, the present invention offers a product design system linking a PDM tool supporting a System Engineering process to a Quality Function Deployment (QFD) tool.

### CLAIM FOR PRIORITY

This application claims the benefit of European Patent Application No. 04300922.4, filed Dec. 20, 2004, which is hereby incorporated herein.

### BACKGROUND OF THE INVENTION

1. Technical Field

The present invention relates generally to a Product Lifecycle Management (PLM) system and method, and more particularly, to a system and method for linking a Quality Function Deployment (QFD) tool to a System Engineering Process.

2. Background Art

Product Lifecycle Management (PLM) allows companies to design, analyze and manage their products from initial conception to retirement by improving the efficiency of product development processes. Within the PLM area, System Engineering is an interdisciplinary approach having a set of tools to enable the realization of successful systems. It may be addressed by Product Data Management (PDM) solutions like the SmartTeam from Dassault Systemes or other well-known commercial solutions such as the one from MatrixOne Inc. or WindChill from Parametric Technology Corporation. The basic purpose of the chosen PDM is to manage all the technical data related to a product throughout its entire lifecycle, from the design requirements to the final operational phase, including the end of the product's life. More information on the PDM systems may be found at http://www.pdmic.com/intropdm.html.

A System Engineering process covers all the phases of a product realization, as shown on FIG. 1. In a primary step, the requirements of a client are collected (102) and next are formulated into technical requirements (104). A functional analysis of the product is set up (106) and a logical architecture of the product is defined (108) to comply with the functional analysis. Then, a physical architecture for the product is designed (110) where appropriate technologies may be selected. Detailed requirements of the parts of the product and of sub-assemblies are then launched (112) and all the components are then integrated in a global design (114). The product may then be manufactured and, once the product is built and sold in the market, the operational and maintenance phases may become active. In a PDM environment, all the product data are configured in a unique vault (repository) that can be linked to various applications used during the process, such as CAD (Computer Aided Design) systems or ERP (Enterprise Resource Planning) solutions.

Additionally, it has become common to use a Quality Function Deployment methodology (QFD) in the early design phase of a product development process in order to map all the clients' needs (or specifications) to the technical features of the product to be designed. Typically, the QFD method starts with the creation of the well-known “House of the Quality,” a structured approach used to translate a set of customer requirements, drawing upon market research and benchmarking data, into an appropriate number of prioritized engineering targets to be met by a new product design. The “House” is made up of six major components, which are completed during a QFD project:

(1) a customer/client requirements list derived from customer statements;

(2) a technical/design requirements set of relevant and measurable product characteristics;

(3) a technical correlation matrix used to identify where technical requirements support or impede each other in the product design;

(4) a mapping matrix illustrating customer perceptions observed in market surveys related to each customer's expectation;

(5) technical priorities, benchmarks and functional targets used to record the priorities assigned to technical requirements by the matrix, measures of technical performance achieved by competitive products, and the degree of difficulty involved in developing each requirement; and

(6) an interrelationship matrix illustrating the QFD team's perceptions of interrelationships between technical and customer requirements.

When run, the QFD method leads to the definition of technical goals and/or recommendations for each design criteria. QFD and the House of Quality concepts have been described in Hauser, J. R. & Clausing, D., 1988, “The House of Quality,” Harvard Business Review, May-June, pp 63-73, which is hereby incorporated by reference. Since then, there have been many proposed improvements to achieve the goals of this methodology. For example, U.S. Pat. No. 5,278,751 describes a system and method for linking Quality Function Deployment data and actual process data. The system uses a knowledge-based expert system in combination with QFD principles to provide an interactive system capable of allowing dynamic changes to a manufacturing process in response to customer input regarding their requirements and ultimate satisfaction.

U.S. Pat. No. 6,535,775 B1 to Bagepalli et al. describes a processor system and method for integrating a Quality Function Deployment tool with a critical-to-quality tool. The method allows for executing quality function deployment at each of a plurality of levels with the quality function deployment tool for a system designable from a respective family of subsystem alternatives. Whereas there is no direct relationship between the QFD and the System Engineering approaches supported by a PDM tool, each is useful to improve the ability of companies to deliver quality products to customers. As previously noted, PDM is used by design organizations which objectives are to ensure that the design of a product perfectly fits with the product requirements, while QFD is a marketing-oriented methodology mainly concerned by compliance with client needs. Combining the two approaches would ease design trade-offs and would help design teams in making the right choices during the design process by having a better view of real user expectations. Moreover, such a combined approach would homogenize concepts and parameters all along the engineering process and align user expectations with corresponding technical requirements.

The present invention offers such a method and system.

### SUMMARY OF THE INVENTION

The present invention is directed to a method, system, and computer program managing a product lifecycle. In a preferred embodiment, the present invention offers a product design system linking a PDM tool supporting a System Engineering process to a Quality Function Deployment (QFD) tool. More specifically, a system to support the System Engineering process taking as inputs the results from the QFD tool (i.e. the user's expectations) is proposed. The input data are the Technical Criteria as defined by the House of Quality. The set of technical features is mapped to the functional analysis and the design of the logical architecture which represent two main steps of the System Engineering process.

An object of the invention is thus to provide a system and achieve a method to link three types of technical data:

(1) technical features (or “criteria”) of a product;

(2) functional components issued by the functional analysis; and

(3) logical and physical architectures.

All those technical data are managed through a PDM tool, which may be linked to an ERP system.

A first aspect of the invention provides a product lifecycle management system comprising: Product Data Management (PDM) means for generating a product design from a client's specifications; Quality Function Deployment (QFD) means for generating engineering specifications from a user's expectations; and means for linking the product design to the engineering specifications.

A second aspect of the invention provides a method for managing a product lifecycle, the method comprising: generating a product design from a client's specifications using a Product Data Management (PDM) tool; generating engineering specifications from a user's expectations using a Quality Function Deployment (QFD) tool; and linking the product design to the engineering specifications.

A third aspect of the invention provides a program product stored on a computer-readable medium, which when executed, manages a product lifecycle, the program product comprising: program code for generating a product design from client's specifications using a Product Data Management (PDM) tool; program code for generating engineering specifications from user's expectations using a Quality Function Deployment (QFD) tool; and program code for linking the product design to the engineering specifications.

A fourth aspect of the invention provides a method for deploying an application for managing a product lifecycle, comprising: providing a computer infrastructure being operable to: generate a product design from a client's specifications using a Product Data Management (PDM) tool; generate engineering specifications from a user's expectations using a Quality Function Deployment (QFD) tool; and link the product design to the engineering specifications.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 is flowchart illustrating the main steps of a System Engineering process;

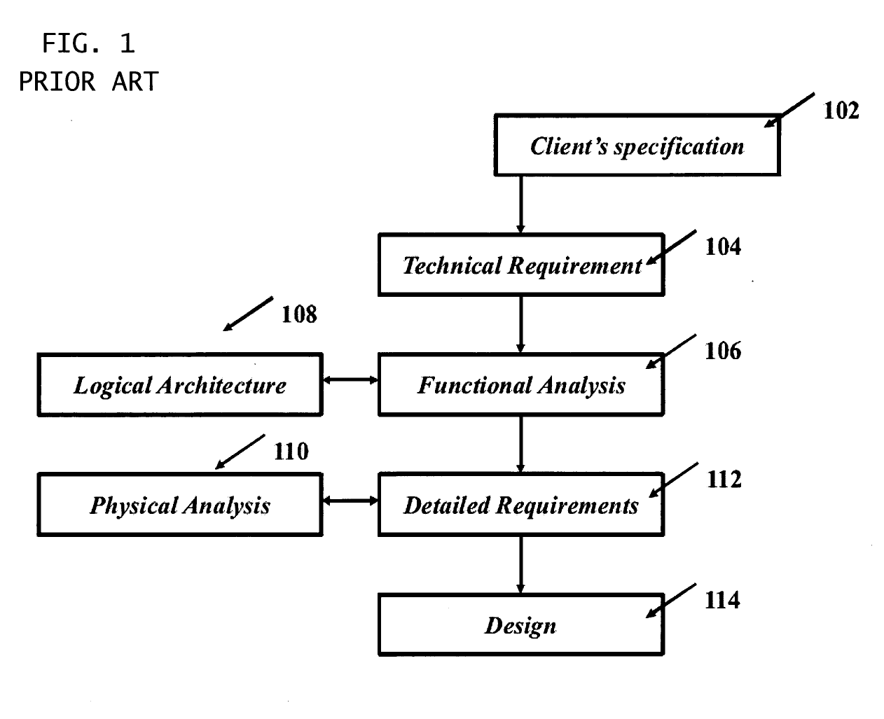

FIG. 2 is a flowchart illustrating the main steps of the process of the present invention;

FIG. 3 shows several correlation matrix to create the relations between the three types of technical data;

FIG. 4 is general schematic view of the system of the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a method, system, and program product for managing a product lifecycle.

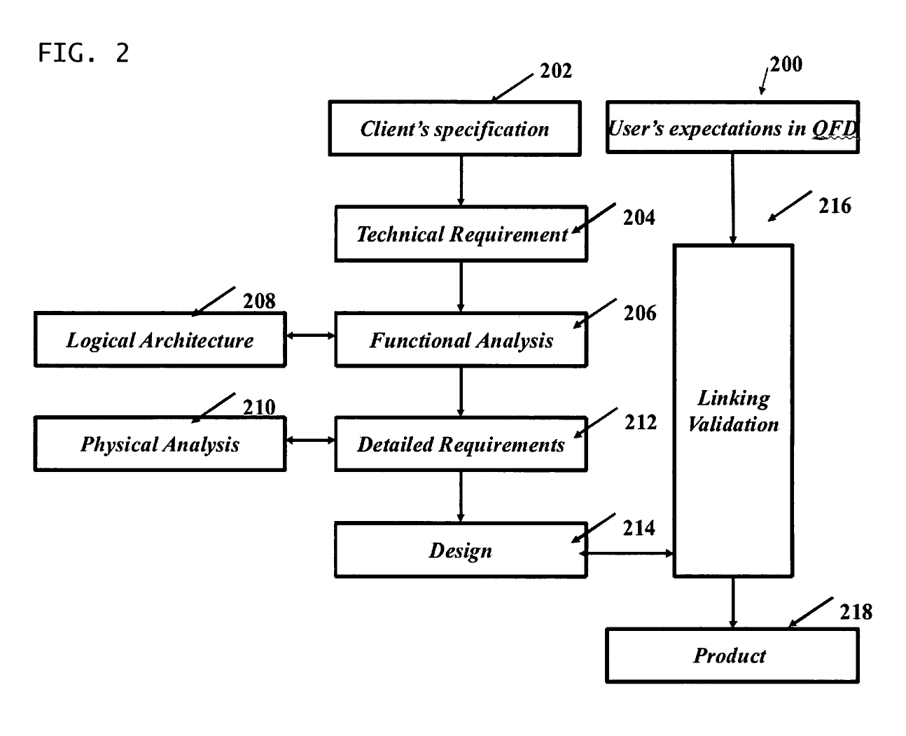

Referring to FIG. 2, a flowchart is shown which includes the main steps required for linking QFD data to PDM data in the present invention. At step 200 a QFD analysis has led to users's expectations issued from a House of Quality. At step 202, client's specifications have been collected and next formatted into technical requirements (step 204). A functional analysis based on the previously formatted data is then made at step 206, and a logical architecture is then directly derived at step 208.

Then, a physical architecture for the product is defined at step 210, where appropriate technologies may be selected. Detailed requirements of the parts of the product and of sub-assemblies are then launched at step 212. All the components are then integrated in a unique design at step 214.

The design is then verified and validated at step 216 with regard to the initial user's expectations. And the final product design may be approved at step 218 once validation is confirmed.

With the previous described process, any modification or update can be managed throughout the design activities, either in case of a change in the requirements about the product, or an engineering change order to increase the performances or to add a new functionality.

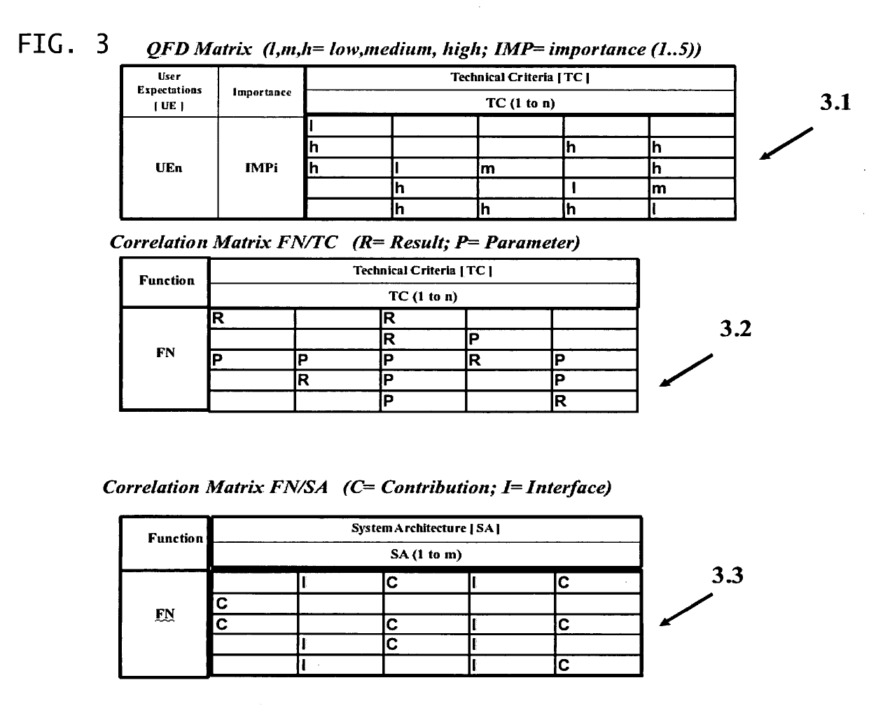

In the former case, the QFD approach will be updated and some new functional criteria will have to be taken into account by the designers. In the second case, the designers will get a remainder information requesting for a new check to remain compliant with the products requirements and therefore keep the product validated, or eventually, will update the QFD analysis with some new user's expectations. Referring now to FIG. 3, several matrices are shown to illustrate how the relationships are established between the different technical data of the QFD and the System Engineering process. Table 3.1 is a QFD matrix that formats the user's expectations (UE) into technical criteria (TC) using importance weights (IMP). It is to be appreciated that no detailed description of the content of such relationship tables is given herein as it will be fully found in any of the aforementioned prior art which is incorporated by reference.

However, to name a few, the technical criteria may be any specific, measurable, available, realistic or time variable features that can be provided by the end user. In a preferred embodiment of the automotive industry where the invention is particularly suitable, the technical criteria (TC) may be a range of temperature, a temperature gradient, the energy to evacuate while parking, the filtration capacity of the exteriors particles to be filtered or a maximum noise level. The corresponding user's expectations—capability to select a temperature, to reach the selected temperature rapidly, to limit the air temperature while parking, to filter the exterior air or to limit the noise at an acceptable level—may be prioritized by assigning an importance weight (IMP) to each one.

Table 3.2 illustrates a correlation matrix to establish the relation between the technical criteria (TC) of Table 3.1 and the functional analysis. The functional analysis allows definition of a breakdown structure of the system using a set of functions (FN). Each function is independent one from each other. Some functions for the previous example of the automotive industry may be to select the desired temperature, to flow the climate air inside the vehicle, to regulate the temperature inside the vehicle, to filter the air from the outside before getting into the vehicle or to clean the air inside the vehicle. Table 3.3 illustrates a correlation matrix to establish the relation between the functions (FN) of Table 3.2 and a system architecture (SA). The logical architecture is directly derived from the functional analysis as previously described. It can also be decomposed into a set of functions and of physical elements or sub-systems, such as a motor, a servo-motor, a regulator, a sensor, for example, in the automotive process which represent the system architecture.

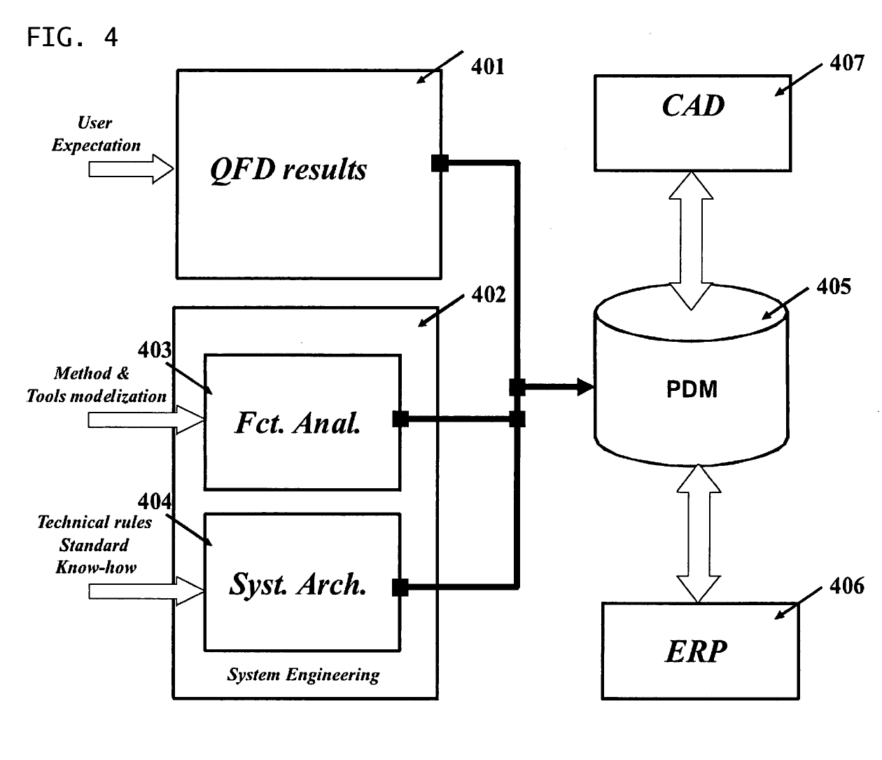

FIG. 4 shows a general view of a product lifecycle management system as used by the present invention. The system comprises a PDM tool (405) for operating a System Engineering process (402) from client's specifications. A Quality Function Deployment tool (401) generates engineering specifications from user's expectations. The data issued from the QFD are linked to the data issued from the System Engineering process. All design-related data issued from the QFD (401), from the Functional Analysis (403) and from the System Architecture (404) are managed in the unique vault of the PDM system (405) to warranty the integrity and coherence of all the data while also warranting the compliance with the user's expectations.

The PDM system may be coupled to a CAD system (407) (or any other modeling tool) and/or to an ERP system (406). All linked data may be stored in the PDM system as a second set of client's specifications so that the design representatives can check at any time during the design phases if the product complies with the user's expectations. Therefore, compliance to the real needs of the users to the product on the market is ensured.

The present invention may be embodied in the form of a program product stored on a computer-readable medium, which when executed, manages a product lifecycle through the operation of processes on a computer system.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A product lifecycle management system comprising:
Product Data Management (PDM) means for generating a product design from a client's specifications;
Quality Function Deployment (QFD) means for generating engineering specifications from a user's expectations; and
means for linking the product design to the engineering specifications.

2. The system of claim 1, wherein the PDM means includes at least one of the following:
means to convert the client's specifications into technical requirements;
means to process a functional analysis from the technical requirements; and
means to generate a system architecture from the functional analysis.

3. The system of claim 1, wherein the linking means comprise means for creating relationships between the engineering specifications and the technical requirements.

4. The system of claim 3, further comprising means coupled to the PDM means for storing the created relationships.

5. The system of claim 1, further comprising Computer Aided Design (CAD) means coupled to the PDM means.

6. The system of claim 1, further comprising Enterprise Resource Planning (ERP) means coupled to the PDM means.

7. A method for managing a product lifecycle, the method comprising:
generating a product design from a client's specifications using a Product Data Management (PDM) tool;
generating engineering specifications from a user's expectations using a Quality Function Deployment (QFD) tool; and
linking the product design to the engineering specifications.

8. The method of claim 7, further comprising:
converting the client's specifications into technical requirements;
processing a functional analysis from the technical requirements; and
generating a system architecture from the functional analysis.

9. The method of claim 8, further comprising:
creating a relationship between the engineering specifications and the technical requirements.

10. The method of 9, further comprising:
storing the created relationship within the PDM tool.

11. A program product stored on a computer-readable medium, which when executed, manages a product lifecycle, the program product comprising:
program code for generating a product design from a client's specifications using a Product Data Management (PDM) tool;
program code for generating engineering specifications from a user's expectations using a Quality Function Deployment (QFD) tool; and
program code for linking the product design to the engineering specifications.

12. The program product of claim 11, further comprising:
program code for converting the client's specifications into technical requirements;
program code for processing a functional analysis from the technical requirements; and
program code for generating a system architecture from the functional analysis.

13. The program product of claim 12, further comprising:
program code for creating a relationship between the engineering specifications and the technical requirements.

14. The program product of claim 13, further comprising:
program code for storing the created relationship within the PDM tool.
